(19) United States
(12) Patent Application Publication
(10) Pub. No.: US 2008/0136622 A1
(43) Pub. Date: Jun. 12, 2008

(54) Wireless Signal Light System Based on Wireless Network and Portable Signal Light

(75) Inventors: Dae-Wha Seo, Daegu (KR); Yun-Jung Lee, Daegu (KR); Byung-Jun Choi, Daegu (KR); Bong-Kee Song, Daegu (KR); Jeen-Hong Park, Gyeongsangbuk-Do (KR); Hong-Rok Kim, Daegu (KR); Jae-Won Park, Gyeongsangbuk-Do (KR)

Correspondence Address: THE RAFFERTY PATENT LAW FIRM, 5641 BURKE CENTRE PKWY, SUITE 100, BURKE, VA, 22015-2259, US

(73) Assignee: KYUNGPOOK NATIONAL UNIVERSITY INDUSTRY-ACADEMIC COOPERATION FOUNDATION, DAEGU (KR)

(21) Appl. No.: 11/816,622

(22) PCT Filed: May 24, 2006
(86) PCT No.: PCT/KR2006/001965

§ 371 Date: Aug. 20, 2007

(30) Foreign Application Priority Data
Aug. 8, 2005 (KR) 10-2005-0072099

(51) Int. Cl. G08B 1/08; G08B 21/00; G08B 25/10

(52) U.S. Cl. 340/539.1; 340/679

(57) ABSTRACT

A wireless network-based portable wireless flashing light system is based on a wireless network-based portable wireless flashing light. The wireless network-based portable wireless flashing light includes a wireless communication module, a display unit, an emergency alarm unit, and a control unit. The wireless communication module transmits and receives a wireless signal to and from an outside. The display unit displays predetermined information. The emergency alarm unit provides notification of an emergency. The control unit extracts status information about manufacturing machines from the signal received from the wireless communication module, displays information about a manufacturing machine in which an abnormality occurs on the display unit based on the status information, and operates the emergency alarm unit.

### TECHNICAL FIELD

The present invention relates, in general, to a wireless network-based portable wireless flashing light system and, more particularly, to a wireless network-based portable wireless flashing light system that makes a user aware of abnormalities of manufacturing machines in a manufacturing line anytime and anywhere on a real-time basis.

### BACKGROUND ART

Typical portable wireless flashing lights are mainly carried in police vehicles, emergency convoy vehicles or the like, and are placed and used on the roofs of the vehicles in the event of emergencies. Flashing lights used in manufacturing lines or the like are fixedly disposed along the manufacturing lines at specific locations, and issue alarm sounds and/or repeatedly turn on and off lamps when a workers presses an operating button or a specific signal is input from outside, thereby notifying surrounding persons of the occurrence of an emergency.

The above-described portable wireless flashing lights mounted on vehicles or the like are inconvenient in that users must carry the lights and manually manipulate operating switches, and are problematic in that they cannot receive signals from outside, or be operated in response thereto.

Meanwhile, the above-described flashing lights installed along manufacturing lines are fixedly installed at specific locations, therefore there are cases where managers are not aware of the operation of the flashing lights when the managers move away from the flashing lights or the flashing lights are out of the line of sight of the managers. Furthermore, when new manufacturing machines are installed in the manufacturing lines, inconvenience arises in that additional cables must be installed and connected to the flashing lights. When the locations of manufacturing machines are changed, inconvenience also arises in that existing signal cables must be removed and new signal cables must be installed. Furthermore, in the case of manufacturing machines that move, signals cannot be transmitted to the flashing lights, therefore problems arise in that, when malfunctions or abnormalities occur in the manufacturing machines, a long time is taken for managers to become aware of the occurrence of such malfunctions or abnormalities, and the manufacturing machines cannot be repaired at the ideal time.

### DISCLOSURE

### Technical Problem

Accordingly, the present invention has been made keeping in mind the above problems occurring in the prior art, and an object of the present invention is to provide a wireless network-based portable wireless flashing light system that is easy to maintain and install, and that can notify a manager of the occurrence of an abnormality in a manufacturing machine in real time.

Another object of the present invention is to provide a portable wireless flashing light that can be used in the above-described portable wireless flashing light system.

### Technical Solution

In order to accomplish the above objects, the present invention provides a wireless network-based portable wireless flashing light, including:

a wireless communication module for transmitting and receiving a wireless signal to and from an outside;

a display unit for displaying predetermined information;

an emergency alarm unit for providing notification of an emergency;

a light emission unit having one or more light-emitting elements, the light-emitting elements being assigned to respective manufacturing machines;

an input switch; and

a control unit for extracting status information about manufacturing machines from the signal received from the wireless communication module, displaying information about a manufacturing machine in which an abnormality occurs on the display unit based on the status information, operating the emergency alarm unit, turning on a corresponding light-emitting element of the light emission unit when an abnormality occurs in a specific manufacturing machine, and stopping operation of the emergency alarm unit and the light emission unit when the input switch operates.

The emergency alarm unit includes at least one of an alarm sound generation unit and a vibration generation unit, and the control unit operates the alarm sound generation unit or the vibration generation unit when an abnormality occurs in a manufacturing machine.

Additionally, the present invention provides a wireless network-based portable wireless flashing light system, including:

a portable wireless flashing light comprising a first wireless communication module, an emergency alarm unit and a control unit;

one or more status information transmission devices for receiving status information about manufacturing machines of a manufacturing line from the manufacturing machines, and transmitting the input status information to an outside through second wireless communication modules respectively installed therein; and

one or more wireless routers for finding shortest routes between the portable wireless flashing light and the status information transmission devices, and transmitting the status information, received from the status information transmission devices, via the found shortest routes;

wherein the control unit of the portable wireless flashing light receives the status information from the wireless routers through the first wireless communication module, and operates the emergency alarm unit when an abnormality in a specific manufacturing machine is detected from the status information.

The portable wireless flashing light further includes a display unit capable of displaying text or the like and an input switch unit which can be operated by a user, and the control unit of the portable wireless flashing light displays information about a manufacturing machine in which an abnormality occurs on the display unit when the abnormality in the manufacturing machine is detected from the status information, and stops operation of the emergency alarm unit when the input switch is operated.

### ADVANTAGEOUS EFFECTS

By operating a portable wireless flashing light via a wireless network based on the present invention, a manager can become aware of the occurrence of an abnormality, even when moving, in real time when abnormalities occur in manufacturing machines, thus enabling prompt maintenance.

Furthermore, a portable wireless flashing light system according to the present invention is based on a wireless network, therefore a manufacturing machine or new equipment can be simply connected to the wireless network without requiring the installation of an additional cable even if the location of the manufacturing machine is changed or new equipment is installed. As a result, the maintenance of manufacturing machines is facilitated and the maintenance cost can be reduced.

Furthermore, a portable wireless flashing light system according to the present invention is based on a wireless network, therefore a manager can be made aware of abnormalities in both stationary manufacturing machines and moving manufacturing machines all the time.

Furthermore, according to the present invention, a manager can correctly be made aware of the occurrence of an abnormality under any circumstances by notifying the manager of the occurrence of an abnormality in a manufacturing machine by various methods, such as a visual method, a tactile sensation method and an audible method, through a portable wireless flashing light.

### DESCRIPTION OF DRAWINGS

FIG. 1 is a diagram illustrating the portable wireless flashing light system according to the overall construction of the present invention; and

FIG. 2 is a block diagram schematically illustrating the portable wireless flashing light of a portable wireless flashing light system according to a preferred embodiment of the present invention.

### BEST MODE

With reference to the accompanying drawings, the construction and operation of a wireless network-based portable wireless flashing light system according to a preferred embodiment of the present invention are described in detail below.

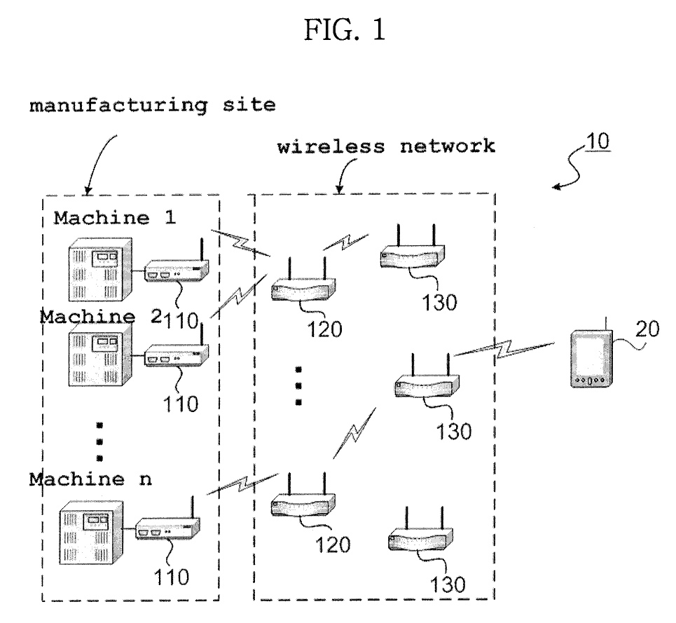

FIG. 1 is a diagram illustrating the portable wireless flashing light system according to the overall construction of the present invention. Referring to FIG. 1, the wireless flashing light system 10 according to the preferred embodiment of the present invention includes a portable wireless flashing light 20, one or more status information transmission devices 110, and one or more wireless routers 120 and 130. The above-described elements are described in detail below.

The status information transmission devices 110 are connected to manufacturing machines in a manufacturing line, and receive information from the manufacturing machines. Furthermore, the status information transmission devices 110 are respectively provided with second wireless communication modules therein, and transmit status information, which is input from the manufacturing machines, to adjacent wireless routers 120 using the second wireless communication modules. In this case, each piece of status information includes information about the identification of a corresponding machine and information about the abnormality in the machine.

The wireless routers 120 and 130 are installed at the site of the manufacturing line, and are each provided with a wireless communication module and a microprocessor unit, thereby receiving status information from adjacent status information transmission devices 110 and transmitting received status information to the portable wireless flashing light 20. At this time, the wireless routers 120 and 130 find the shortest routes to the portable wireless flashing light 20, and transmit the status information to the portable wireless flashing light 20 via the shortest routes.

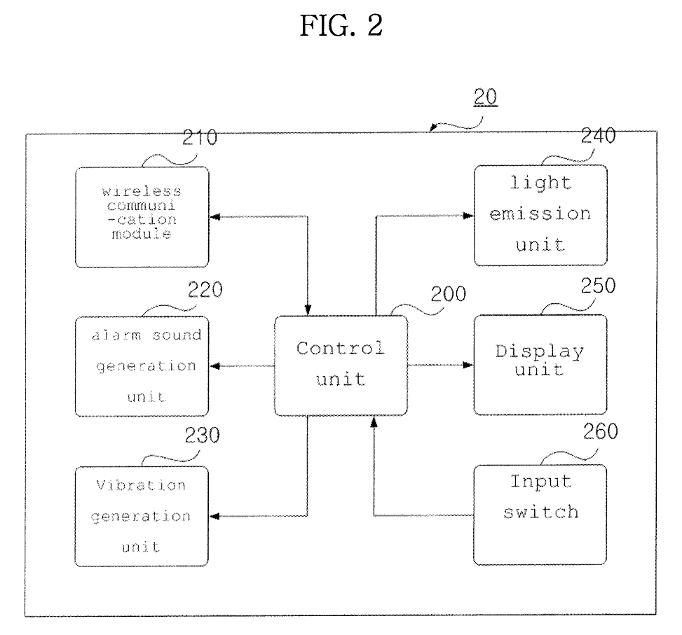

With reference to FIG. 2, the construction and operation of a portable wireless flashing light 20 according to a preferred embodiment of the present invention are described in detail below.

Referring to FIG. 2, the portable wireless flashing light 20 according to the preferred embodiment of the present invention includes a control unit 200, a first wireless communication module 210, an alarm sound generation unit 220, a vibration generation unit 230, a light emission unit 240, a display unit 250, and an input switch 260. The above-described elements of the portable wireless flashing light 20 are described in detail below.

The control unit 200 controls the other elements that constitute the portable wireless flashing light.

The first wireless communication module 210 transmits and receives signals to and from the wireless router, and transmits signals, received from the wireless router, to the control unit 200. The first and second wireless communication modules are modules capable of wirelessly communicating with the wireless router. Each of the first and second wireless communication modules may be one of a Wireless Local Area Network (WLAN) communication module, a Bluetooth communication module and a Zigbee communication module. Additionally, one of the communication modules for supporting short distance communication may be used as each of the first and second wireless communication modules.

The alarm sound generation unit 220 includes a speaker and an amplifier, and issues an alarm sound in response to an operation control signal from the control unit.

The vibration generation unit 230 includes a vibration motor, and vibrates in response to an operation control signal from the control unit.

The light emission unit 240 includes a plurality of light-emitting elements, which are respectively assigned to manufacturing machines or groups of manufacturing machines of the manufacturing line. When an abnormality in a specific manufacturing machine is detected, the control unit notifies a manager of the abnormality of the manufacturing machine by turning on the light-emitting element to which the manufacturing machine is assigned.

Light-Emitting Diodes (LEDs) or small-size lamps may be used as the light-emitting elements that constitute the light emission unit 240.

A Liquid Crystal Display (LCD) may be used as the display unit 250, and the display unit 250 displays information that is transmitted from the control unit.

The input switch 260 is a switch that can be operated by the manager. When the input switch is operated, the control unit 200 stops the operation of the alarm sound generation unit, the vibration generation unit and the light emission unit.

Meanwhile, as described above, when a certain signal is received from the first wireless communication module, the control unit 200 of the portable wireless flashing light 20 extracts status information about the manufacturing machines from the received signal, displays information about the manufacturing machines in which abnormalities occurred on the display unit 250 based on the extracted status information, and notifies the manager of the occurrence of the abnormalities by operating the alarm sound generation unit 220, thus issuing an alarm sound, operating the vibration generation unit 230, thus vibrating the portable wireless flashing light, and turning on the light-emitting elements to which the corresponding manufacturing machines are assigned.

Meanwhile, when the manager, having detected the occurrence of the abnormalities, manipulates the input switch 260 and the control unit 200 consequently detects a signal from the input switch, the control unit 200 stops the operation of the vibration generation unit, the alarm sound generation unit and the light emission unit.

Although the present invention has been described based on the preferred embodiment thereof, the embodiment is only illustrative and does not limit the present invention. It can be understood that those having ordinary skill in the field to which the present invention pertains can achieve various modifications and applications that are not illustrated herein, without departing from the essential characteristics of the present invention. For example, in the embodiment of the present invention, a means for notifying a manager of the occurrence of an abnormality in a specific manufacturing machine, other than the alarm sound generation unit or the vibration generation unit, may be added. This emergency alarm means may be modified and then used in various ways. Furthermore, it should be understood that the differences associated with the modifications and applications are included in the scope of the present invention, which is defined in the accompanying claims.

### INDUSTRIAL APPLICABILITY

The wireless network-based portable wireless flashing light system and portable wireless flashing light according to the present invention can be widely used in factory automation systems, manufacturing factories or manufacturing sites.

1. A wireless network-based portable wireless flashing light, comprising:
a wireless communication module for transmitting and receiving a wireless signal to and from an outside;
a display unit for displaying predetermined information;
an emergency alarm unit for providing notification of an emergency; and
a control unit for extracting status information about manufacturing machines from the signal received from the wireless communication module, displaying information about a manufacturing machine in which an abnormality occurs on the display unit based on the status information, and operating the emergency alarm unit;
wherein the wireless network-based portable wireless flashing light is operated by the control unit according to the wireless signal received from the outside.

2. The wireless network-based portable wireless flashing light as set forth in claim 1, wherein the emergency alarm unit comprises at least one of an alarm sound generation unit and a vibration generation unit, and the control unit operates the alarm sound generation unit or the vibration generation unit when the abnormality occurs in the manufacturing machine.

3. The wireless network-based portable wireless flashing light as set forth in claim 1, further comprising a light emission unit having one or more light-emitting elements;
wherein the light-emitting elements are assigned to respective manufacturing machines, and the control unit turns on a corresponding light-emitting element of the light emission unit when an abnormality occurs in a specific manufacturing machine.

4. A wireless network-based portable wireless flashing light system, comprising:
a portable wireless flashing light comprising a first wireless communication module, an emergency alarm unit and a control unit;
one or more status information transmission devices for receiving status information about manufacturing machines of a manufacturing line from the manufacturing machines, and transmitting the input status information to an outside through second wireless communication modules respectively installed therein; and
one or more wireless routers for finding shortest routes between the portable wireless flashing light and the status information transmission devices, and transmitting the status information, received from the status information transmission devices, via the found shortest routes;
wherein the control unit of the portable wireless flashing light receives the status information from the wireless routers through the first wireless communication module, and operates the emergency alarm unit when an abnormality in a specific manufacturing machine is detected from the status information.

5. The wireless network-based portable wireless flashing light system as set forth in claim 4, wherein the portable wireless flashing light further comprises a display unit capable of displaying text or the like, and the control unit of the portable wireless flashing light displays information about a manufacturing machine in which an abnormality occurs on the display unit when the abnormality in the manufacturing machine is detected from the status information.

6. The wireless network-based portable wireless flashing light system as set forth in claim 4, wherein the portable wireless flashing light further comprises an input switch unit which can be operated by a user, and the control unit stops operation of the emergency alarm unit when the input switch is operated.
